(19) United States
(12) Patent Application Publication
(10) Pub. No.: US 2026/0186990 A1
(43) Pub. Date: Jul. 2, 2026

(54) MEMORY MODULE AND METHOD FOR WRITING DATA THERETO

(71) Applicant: Ferroelectric Memory GmbH, Dresden (DE)

(72) Inventors: Maher Amer, Nepean (CA); Torsten Coym, Dresden (DE)

(21) Appl. No.: 19/004,571

(22) Filed: Dec. 30, 2024

(51) Int. Cl. G06F 13/16; G06F 12/1009; G06F 13/42

(52) U.S. Cl. CPC G06F 13/1673; G06F 12/1009; G06F 13/4221

(57) ABSTRACT

Various aspects relate to a memory module including: a memory interface; a non-volatile storage device for persistently storing data; a non-volatile memory device providing a write first in first out, FIFO, buffer in hardware, the write FIFO buffer being configured to receive, via the memory interface, and to store packets associated with one or more atomic transactions, wherein each of the one or more atomic transactions includes a respective plurality of packets and indicates corresponding data to be written to the memory module; a memory controller configured to write the corresponding data of an atomic transaction of the one or more atomic transactions to the memory module in the case that the write FIFO buffer stores the respective plurality of packets of the atomic transaction.

### TECHNICAL FIELD

Various aspects relate to a memory module and a method for writing data thereto.

### BACKGROUND

In general, various computer memory technologies have been developed in semiconductor industry. Various memory devices, such as solid-state drives (SSD), include a non-volatile (e.g., flash) storage for persistently storing data and a volatile dynamic random-access memory (DRAM) that provides a cache for volatilely storing data when updating data of the non-volatile storage. To ensure data coherency on the non-volatile storage, viz. to ensure that data are never written partially (hence, only written in its entirety), there has to be a locking mechanism on the non-volatile storage device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1 shows a storage locking mechanism for ensuring data coherency of a storage device;

FIG. 2 and FIG. 3 each show a memory module including a write FIFO buffer according to various aspects;

FIG. 4 shows exemplary packet formats according to various aspects;

FIG. 5A and FIG. 5B each show exemplary packets stored in the write FIFO buffer according to various aspects;

FIG. 6 shows a page table of the memory module including the write FIFO buffer according to various aspects;

FIG. 7 shows the write FIFO buffer according to various aspects;

FIG. 8A to FIG. 8D show various aspects of a checkpoint operation for generating a checkpoint of the non-volatile storage device according to various aspects; and

FIG. 9 shows a flow diagram of a method for writing data to a memory module according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., a memory cell, or a memory capacitor). However, it may be understood that aspects described in connection with methods may similarly apply to the devices, and vice versa.

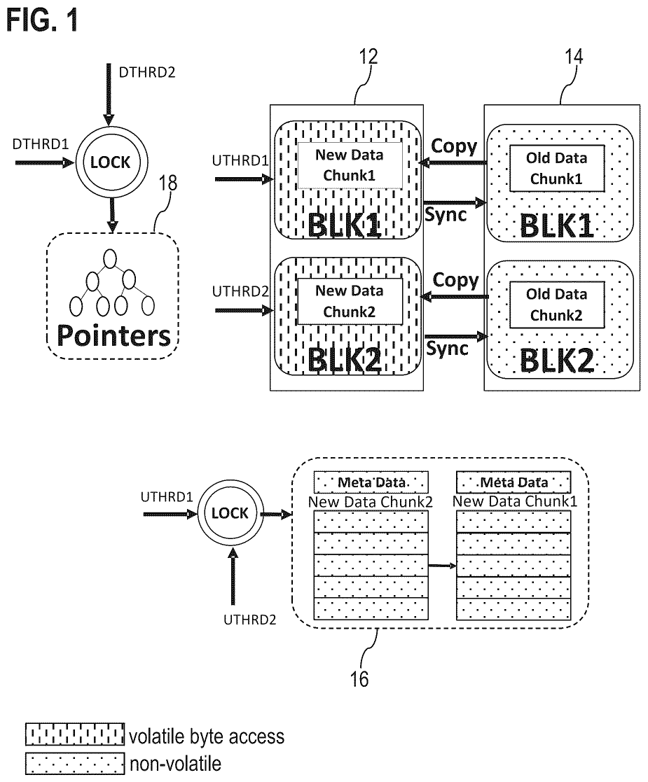

In general, storage devices may require to maintain coherent data at all times (including unexpected system failure). Illustratively, data coherency of the (non-volatile) storage device has to be ensured. The phrase “data coherency”, as used herein, may be understood to mean that new data are never written partially, but only in its entirety. If there is, for example, a system failure prior to receiving all new data, the old data are to be restored (and not the part of the new data received). Commonly, this is provided using a locking mechanism, as exemplarily shown in FIG. 1.

With reference to FIG. 1, a storage module may include a memory device 12 and a non-volatile storage device 14.

Page data may be stored in a corresponding page in the memory device 12 or the storage device 14. Therefore, the storage module may include a logical-to-physical (L2P) address translation with pointers 18 pointing to the physical address of the memory device 12 and/or storage device 14 at which respective page data are stored. According to various aspects, an L2P table may include a logical block address (short: logical address) and a physical block address (short: physical address) of the page data for L2P address translation. Illustratively, the logical addresses may provide an abstract (e.g., virtual) address for software (e.g., the application implemented by the processing unit of the host 200) to interact with the memory storage module, whereas the physical addresses represent actual hardware locations on the storage module. The logical block address may also be referred to as virtual block address (short: virtual address).

When having a first user thread, UTHRD1, that wants to write first new data (viz. a new data chunk 1) to a first page in a first block, BLK1, and a second user thread, UTHRD2, that wants to write second new data (viz. a new data chunk 2) to a second page to a second block, BLK2, on a non-volatile storage device 14, the first page and the second page are copied to the memory device 12.

To ensure data coherency, viz. to ensure that the first new data (viz. the new data chunk 1) and the second new data (viz. the new data chunk 2) are not written partially, but only fully, the first new data and the second new data are first written to a (non-volatile) log 16. However, since the first user thread, UTHRD1, and the second user thread, UTHRD2, are both writing data to the log 16, the first user thread, UTHRD1, and the second user thread, UTHRD2, have to be synchronized. For synchronization, the pointers 18 pointing to the physical address of the first page and to the physical address of the second page have to be updated accordingly (by corresponding device threads, DTHRD1 and DTHRD2).

Once the first new data (viz. the new data chunk 1) are fully written to the log 16, the first new data are merged with the first page data in the memory device 12 and then written to the storage device 14. The same applies to the second new data. Hence, once the second new data (viz. the new data chunk 2) are fully written to the log 16, the second new data are merged with the second page data in the memory device 12 and then written to the storage device 14.

Thus, there are two write operations, one write operation to the log 16 and another one to the memory device 12.

Thus, the coherency requirement imposes challenges including double write and extra locking on the non-volatile log 16. Therefore, storage has a reduced performance as compared to memory which has no coherency requirement (and, thus, no thread locking).

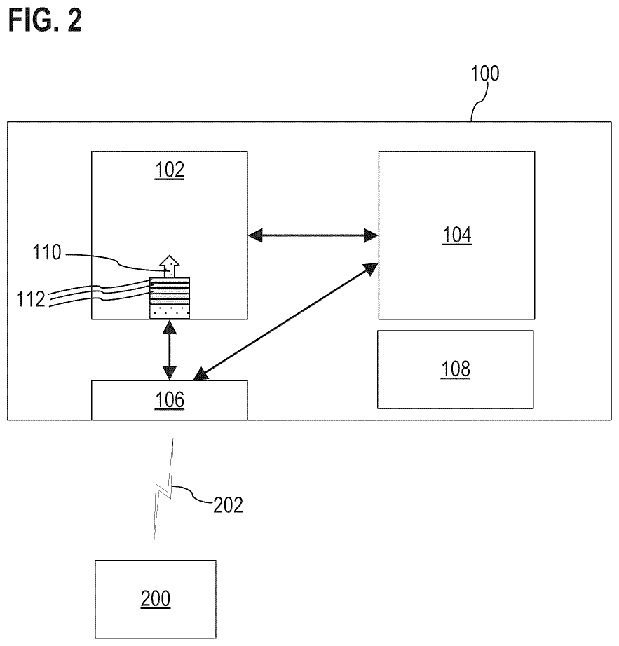

FIG. 2 shows a memory module 100 according to various aspects. This memory module 100 allows to eliminate those double-writes and locking while still ensuring coherency. This is achieved by ensuring the data coherency and the thread synchronization (completely) by hardware. This is a step towards converging memory and storage. The memory module 100 may, for example, be or include a solid-state drive (SSD).

The memory module 100 may include a non-volatile memory device 102 and a non-volatile storage device 104. The memory module 100 detailed herein may be configured to persistently store data. Hence, illustratively, the memory module 100 may provide data storage.

The term “storage”, as used herein, may refer to a unit configured to persistently, i.e. non-volatilely, store data. Illustratively, the non-volatile storage device 104 may serve for permanent data storage. Thus, the non-volatile storage device 104 may store the data also once the power is removed. As an example, the non-volatile storage device 104 may be a non-volatile flash storage, such as a non-volatile NAND flash storage. It is understood that this serves as an example for illustration and that the memory cells of the non-volatile storage device 104 may have any other kind of configuration.

The term “memory”, as used herein, may refer to a unit allowing for a volatile data access. A volatile memory may require constant power in order to store data. Thus, once the power is lost, the stored data are gone. Hence, a volatile memory may store data non-persistently. Since the memory device 102 is a non-volatile memory device 102 (in various aspects described in short as memory device 102), the memory device 102 is capable to persistently store data.

The memory module 100 may include a memory controller 108. The memory controller 108 may be configured to control the units of the memory module 100. Thus, the memory controller 108 may be, for example, configured to control read and/or write operations on the memory module 100. Herein, when referring to an action being carried out by at least one of the elements of the memory module 100, the memory controller 108 may be configured to control the at least one element accordingly.

The memory module 100 may include a memory interface 106. The memory interface 106 may be configured to receive data from a host 200 (e.g., a processing unit (e.g., a central processing unit), e.g., of a user device) via a communication channel 202 (e.g., to write the data to the memory module 100). The memory interface 106 may be configured to transmit data to the host 200 via the communication channel 202 (e.g., to provide data that are read from the memory module 100 responsive to the host 200 requesting them). The processing unit of the host 200 may implement an application interacting with the memory module 100 via the memory interface 106.

The memory interface 106 may be any kind of interface that allows to directly address the memory device 102 (and the write FIFO buffer 110 described herein). As an example, the memory interface 106 may be a Compute Express Link (CXL) interface.

Compute Express Link (CXL) is an open standard interconnect for high-speed, high-capacity central processing unit (CPU)-to-device and CPU-to-memory connections, designed for high performance data center computers. CXL is built on the serial PCI Express (PCIe) physical and electrical interface and includes PCIe-based block input/output protocol (CXL.io) and cache-coherent protocols for accessing system memory (CXL.cache) and device memory (CXL.mem).

Compute Express Link (CXL) includes a CXL input/output (CXL.io) protocol that allows to address the memory module 100 to, for example, provide new page data (e.g., of 4 kB size) that are to be written to the memory module 104 and/or to provide other data, such as registration data for registering a namespace, etc. Further CXL includes a CXL memory (CXL.mem) protocol that allows to directly address the memory device 102 (with up to 64 kB). According to various aspects, the memory device 102 may be a byte-addressable memory. The CXL.mem protocol is an example of providing the byte-addressability of the memory device 102. It is understood that this serves as an exemplary protocol and that any other protocol may be used that allows to directly (byte-) address the memory device 102. The memory device 102 may also be referred to as host-managed device memory (HDM).

The direct addressability of the memory device 102 (e.g., by using the CXL. mem protocol) allows to write data having a data size less than the page data size (viz. a fraction of page data) to page data of a page, thereby reducing the amount of host-device data movement.

According to various aspects, the memory module 100 may include a write first-in first-out (FIFO) buffer 110 in hardware. The write FIFO buffer 110 may be configured to store data persistently. In the following, the non-volatile memory device 102 is described as providing the write FIFO buffer 110. Hence, a memory portion of the non-volatile memory device 102 may be dedicated to provide the write FIFO buffer 110. Implementing the write FIFO buffer 110 as a portion of the non-volatile memory device 102 may be advantageous since both, the non-volatile memory device 102 and the write FIFO buffer 110 may be required to be non-volatile (viz. persistent), byte-addressable, and comparatively fast (e.g., similar to DRAM). It is understood that this is an advantageous implementation and that the write FIFO buffer 110 may be implemented as a hardware device separate to the non-volatile memory device 102. Hence, according to various aspects, the write FIFO buffer 110 may be implemented physically in any suitable manner as long as the write FIFO buffer 110 is byte-addressable and configured to store data persistently.

The write FIFO buffer 110 detailed herein allows to move the data transaction management and the thread synchronization to the hardware of the memory module 100. As detailed herein, this allows to omit the locking mechanism described with reference to FIG. 1 and to reduce the load of the host 200 processing unit (e.g., central processing unit, CPU). Further, only a single write operation is required for writing new data (as compared to the double write described with reference to FIG. 1).

According to various aspects, the write FIFO buffer 110 may be directly addressable by the host 200 via the memory interface 106.

According to various aspects, the write FIFO buffer 110 may be addressable by at least one predefined physical address (different from the physical addresses at which the page data are stored) using a protocol (e.g., the CXL.mem protocol) providing the direct addressability of the memory device 102. Illustratively, at least one predefined physical address may be used to push packets into the hardware queue of the write FIFO buffer 110. Hence, the at least one predefined physical address may be predefined before the host 200 application starts.

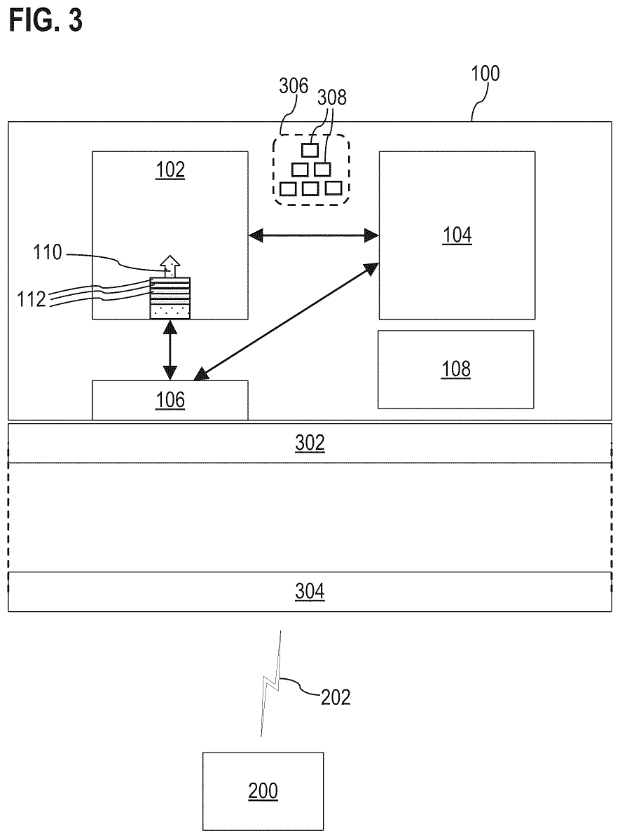

With reference to FIG. 3, for accessing the memory module 100, an application running on the host 200 may map the physical addresses of the memory module 100 (including the physical addresses of the non-volatile storage device 104 and the physical addresses of the memory device 102) to logical (e.g., virtual) addresses. Illustratively, the whole capacity of the memory module 100 is mapped as (static) addresses. The host 200 may map the data stored in the memory module 100 to a file system by memory mapping, MMAP) to, for example, get rid of all page faults in the host 200). Illustratively, from application perspective, the memory is accessed (e.g., by CXL.mem) without knowing that the capacity of the non-volatile storage device 104 is provided as well. Thus, there may be a physical memory 302 of the memory module 100 and a logical (e.g., virtual) memory 304 mapping the physical memory 302 to a file system provided to the host 200 application.

The memory module 100 may include a page table 306. The page table 306 may include the plurality of page table entries 308. Each page table entry (PTE) of the plurality of page table entries 308 may include the logical (e.g., virtual) address of a corresponding page and the physical address of the page (viz. the physical address at which the page data of the page are stored). As detailed herein, in the case of the memory mapping (MMAP), the physical address may refer to a page of the non-volatile memory device 102 and/or of the non-volatile storage device 104.

The write FIFO buffer 110 may be configured to receive and store packets 112 of one or more atomic transactions. An atomic transaction may represent a data update to page data of a respective page stored in the memory module 100 (e.g., the non-volatile storage device 104 and/or the non-volatile memory device 102). A transaction may be an atomic transaction when including a plurality of packets, of which two or more packets include a portion of the data update. For example, the CXL.mem protocol may ensure the atomicity by allowing each packet of the atomic transaction to have 64 Bytes.

To ensure thread synchronization, an operating system (OS) of the memory module 100 may allow the host 200 application to register a thread to have write permission to one or more corresponding physical addresses of the memory module 104. For example, the host 200 application may use the CXL.io protocol to register a thread for write permission. For example, the application may get a process identifier (ID) and a key indicating write permission of the registered thread.

The host 200 application may be associated with a namespace. This may allow multi-tenancy such that multiple applications can access the memory module 100. A namespace may be bijectively assigned to a corresponding memory portion. Thus, a page of the mapped memory may be bijectively assigned to a namespace such that other namespaces have no access to this page. For example, the host 200 application may use the CXL.io protocol to register a namespace.

When receiving via the memory interface 106 a packet of a corresponding atomic transaction that indicates a thread but not the permitted process ID and key, the memory controller 108 may be configured to prevent the packet from being stored in the write FIFO buffer 110. Thus, the memory controller 108 may be configured to only store packets in the write FIFO buffer 110 that have the write permission. This ensures thread synchronization (in hardware). Illustratively, the write permission (also referred to as access permission) is carried out in hardware prior to storing the packets in the write FIFO buffer 110.

Illustratively, the memory module 100 provides data coherency (and thread synchronization) in hardware, whereas the locking mechanism described with reference to FIG. 1 is at least partially implemented in software and requires various operations by the host 200 CPU. Illustratively, the write FIFO buffer 110 provides the log 16, the memory mapping (MMAP) 302, 304 in combination with the page table 306 provides synchronization of the pointers 18, the non-volatile memory device 102 provides the byte-access, and the non-volatile storage device 104 provides the storage.

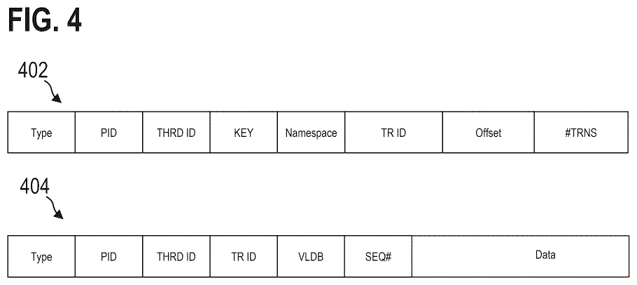

FIG. 4 shows exemplary packet formats a packet stored in the write FIFO buffer 110 may have. For example, the plurality of packets of an atomic transaction may include one or more status packets 402 and a plurality of data packets 404.

The one or more status packets may, for example, include a start packet (Type =STRT). The start packet may indicate a start of the corresponding atomic transaction. The start packet may indicate a start of the corresponding atomic transaction. The start packet may indicate the registered thread (given by the thread ID, THRD ID), the process ID (PID) of the registered thread and the key (KEY) of the registered thread to allow the memory controller 108 to carry out the permission check. The start packet may further indicate the namespace to allow for multi-tenancy. Since a registered thread may write data by multiple packets, the start packet may indicate a transaction ID (TR ID) and the physical address (given by the Offset within the namespace). Optionally, the start packet may indicate the number (#TRNS) of data packets the plurality of packets of the atomic transaction, TR ID, includes.

The one or more status packets may, for example, include an end packet. The end packet may indicate reception of all packets of the plurality of packets (viz. reception of all #TRNS data packets) of the atomic transaction, TR ID.

To correlate a data packet to the status packet(s), each data packet of the plurality of data packets 404 (Type=DATA) may indicate the process ID (PID), the thread (THRD ID), the transaction ID (TR ID), and may include a data portion. Optionally, the data packet may indicate the number of valid bytes (VLDB) and/or a sequence number (SEQ#).

According to various aspects, the memory controller 108 may be configured to write the data (update) of an atomic transaction, TR ID, to the memory module 100 (e.g., the non-volatile storage device 104) in the case that the write FIFO buffer 110 stores all packets of the atomic transaction, TR ID. Illustratively, the data (update) are only written to the (corresponding page of the) memory module 100 in the case that there is a complete (or full) atomic transaction, viz. that there are all packets of the atomic transaction available. This ensures data coherency without any access locking. Thus, the data are only written to the memory module 100 once they are coherent. Further, to write (e.g., merge) the data, no further interaction with the host 200 CPU is required, but the write (e.g., merge) operation is carried out completely in hardware by back-pressuring the memory controller 108. This improves the performance of the memory module 100 significantly.

According to various aspects, the data of the complete atomic transaction may be merged with the corresponding page data in the non-volatile memory device 102 and the merged data may then be written to the non-volatile storage device 104 for storage.

Illustratively, the write FIFO buffer 110 allows to directly write new data to a page of the memory module 100 without priorly writing them to a log.

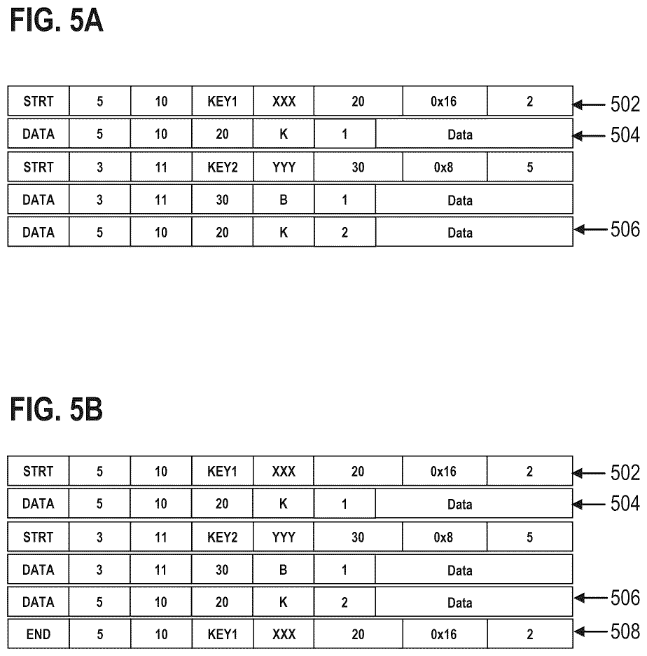

FIG. 5A and FIG. 5B each show exemplary packets stored in the write FIFO buffer 110. FIG. 5A shows an example in which the one or more status packets 402 do not include the end packet. The memory controller 108 may determine that all data packets of the atomic transaction, TR ID, 20 are received by determining that the start packet 502 of the atomic transaction, TR ID, 20 indicates that the atomic transaction, TR ID, 20 includes two data packets (#TRNS=2) and that the write FIFO buffer 110 includes two data packets 504, 506 of the atomic transaction, TR ID, 20. FIG. 5B shows an example in which the one or more status packets 402 include the end packet 508. In this case, reception of the end packet 508 may trigger the memory controller 108 to know that the two data packets 504, 506 of the atomic transaction, TR ID, 20 are received. Using the end packet 508 improves the performance of the memory module 100 since the memory controller 108 does not have to scan the packets in the write FIFO buffer 110 in order to determine whether all data packets of an atomic transaction is received and stored in the write FIFO buffer 110.

To empty the write FIFO buffer 110 from the plurality of packets 502, 504, 506, 508 of the atomic transaction, TR ID, 20 and to write the corresponding data of the atomic transaction, TR ID, 20 to the non-volatile storage device 104 (e.g., via the non-volatile memory device 102 as described herein), the memory controller 108 may be configured to sort the packets stored in the write FIFO buffer 110 to coalesce and to output only the packets of the atomic transaction, TR ID, 20 (by flushing the write FIFO buffer 110).

The memory controller 108 may be configured to write the corresponding data of the atomic transaction, TR ID, 20 to the non-volatile storage device 104 by copying the page data of the page at the physical address indicated by the Offset of the start packet 502 (viz. 0x16) to the memory device 102, by generating new page data by merging the corresponding data of the atomic transaction, TR ID, 20 with the page data in the memory device 102, and by writing the new page data to the page in the non-volatile storage device 104.

Illustratively, using the write FIFO buffer 110 allows to move the data coherency to the hardware of the memory module 100 and does not require any locking mechanism, thereby significantly increasing the performance of the memory module 100.

As detailed herein, the memory device 102 of the memory module 100 may be a non-volatile memory device 102. This allows the memory controller 108 to be configured to opportunistically write the corresponding data of the atomic transaction, TR ID, 20 to the non-volatile storage device 104. Hence, since the corresponding data are also stored non-volatilely in the write FIFO buffer 110, there is no need to immediately write the corresponding data to the non-volatile storage device 104. This increases the performance of the memory module 100 significantly since the write load is controllable.

According to various aspects, the memory controller 108 may be configured to opportunistically write the corresponding data of complete atomic transactions to the non-volatile storage device 104 while ensuring that the write FIFO buffer 110 does not run full. In the case that the write FIFO buffer 110 would be full, no packets can be stored therein, thereby resulting in that writes by the host 200 application would not be accepted.

As an example of a non-volatile memory device 102, the memory cells of the memory device 102 may be remanent-polarizable memory cells. A remanent-polarizable memory cell may be writable into at least two (different) remanent polarizable memory states. For this, the memory cell may include a capacitive memory structure, such as a spontaneously polarizable capacitor, SPOC, structure. Therefore, the memory cell may also be referred to as a capacitive memory cell or a capacitor-type memory cell. The SPOC structure may include at least one capacitor. The capacitor may include a memory element disposed between at least two electrodes (e.g., two electrode layers). The SPOC structure may include the at least one capacitor and an access transistor. For example, the memory cell may be a one transistor, T, one capacitor, C, memory cell (1T1C cell). It is understood that this serves for illustration and that the memory cell may include more than one capacitor, thus being a one transistor multiple capacitors memory cell (1TxC cell). Thus, the memory state of the memory cell may be associated with a (remanent) polarization state of the SPOC structure. The (remanent) polarization state of the SPOC may determine the amount of charge stored therein. The amount of charge stored in the SPOC structure may be used to define the memory state of the memory cell. Thus, writing the memory cell may be associated with applying an electric field over the SPOC structure to thereby set (e.g., change) the (e.g., remanent) polarization state of the SPOC structure.

The memory element of the SPOC structure may include or may consist of a spontaneously polarizable material. For example, the spontaneously polarizable material may be a remanent polarizable material, such as a ferroelectric material, or a non-remanent polarizable material, such as an anti-ferroelectric material. A memory element including or consisting of a spontaneously polarizable material may be understood such that the memory element has (e.g., within the framework of the SPOC structure) spontaneously polarizable properties. Thus, the SPOC structure may provide a spontaneously polarizable capacitor (in some aspects also referred to as memory capacitor).

The spontaneously-polarizable memory element may show a hysteresis in the (voltage (drop) dependent) polarization. The spontaneously-polarizable memory element may show non-remanent spontaneous polarization (e.g., may show anti-ferroelectric properties), e.g., the spontaneously-polarizable memory element may have no or no substantial remanent polarization remaining in the case that no voltage drops over the spontaneously-polarizable memory element. In other aspects, the spontaneously-polarizable memory element may show remanent spontaneous polarization (e.g., may show ferroelectric properties), e.g., the spontaneously-polarizable memory element may have a remanent polarization or a substantial remanent polarization remaining in the case that no voltage drops over the spontaneously-polarizable memory element.

The terms “spontaneously polarized” or “spontaneous polarization” may be used herein, for example, with reference to the polarization capability of a material beyond dielectric polarization. A “spontaneously-polarizable” (or “spontaneous-polarizable”) material may be or may include a spontaneously-polarizable material that shows a remanence, e.g., a ferroelectric material, and/or a spontaneously-polarizable material that shows no remanence, e.g., an anti-ferroelectric material. The coercivity of the spontaneously-polarizable material may be a measure of the strength of the reverse polarizing electric field that may be required to remove a remanent polarization. In some aspects, the memory element may be remanent-polarizable, thereby providing the remanent polarization capability of the SPOC structure. In other aspects, the memory element may consist of a material that is spontaneously polarizable but shows no remanence (e.g., an anti-ferroelectric material) and additional conditions are implemented to generate an internal electric-field within the anti-ferroelectric material to thereby provide the remanent polarization capability of the SPOC structure. Hence, a non-remanent polarizable material, such as an anti-ferroelectric (“antiferroelectric”) material may exhibit remanent polarizable properties within certain structures. An internal electric-field within an anti-ferroelectric material may be caused (e.g., applied, generated, maintained, as examples) by various strategies: e.g., by implementing floating nodes that may be charged to voltages different from zero volts, and/or by implementing charge storage layers, and/or by using doped layers, and/or by using electrode layers that adapt electronic work-functions to generate an internal electric field, by using an encapsulation structure which introduces compressive stress or tensile stress onto the memory element, thereby establishing the spontaneously polarizable properties, only as examples.

A spontaneous polarization (e.g., a remanent or non-remanent spontaneous polarization) may be evaluated via analyzing one or more hysteresis measurements (e.g., hysteresis curves), e.g., in a plot of polarization, P, versus electric field, E, in which the material is polarized into opposite directions. The polarization capability of a material (dielectric polarization, spontaneous polarization, and a remanence characteristics of the polarization) may be analyzed using capacity spectroscopy, e.g., via a static (C-V) and/or time-resolved measurement or by polarization-voltage (P-V) or positive-up-negative-down (PUND) measurements. Another method for determining a polarization capability of a state-programmable memory element may include transmission electron microscopy, e.g., an electric-field dependent transmission electron microscopy.

Hence, according to various aspects, the memory device 102 may be a remanent-polarizable memory, such as a remanent-polarizable non-volatile random-access memory. As an example, the remanent-polarizable non-volatile random-access memory may be a ferroelectric non-volatile random-access memory, FeNVRAM. According to other aspects, the memory device 102 may be a magnetoresistive random-access memory (MRAM) or a resistive random-access memory (RRAM). It is understood that these non-volatile memories serve as examples and that the memory device 102 may be any other kind of non-volatile memory.

Each namespace of one or more namespaces may be associated with a corresponding page table including a plurality of page table entries, with each page table entry of the plurality of page table entries being bijectively assigned to specific page data and indicating the logical address used by the host 200 application for accessing the page data and the physical address indicating the page at which the page data are stored in the memory module 100.

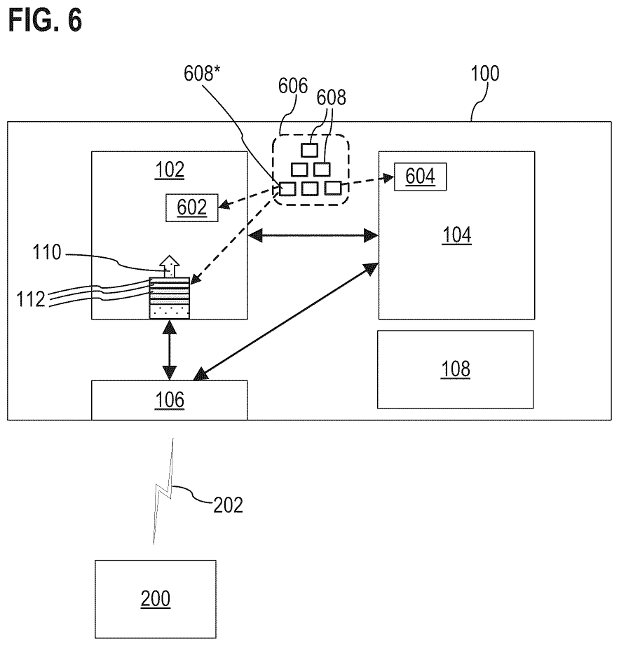

FIG. 6 shows an exemplary page table 606 (of a corresponding namespace) according to various aspects. The page table 606 may include the plurality of page table entries 608. As an example, there may be a first page table entry indicating (e.g., pointing to) a first page 602 stored in the memory device 102 and a second page table entry indicating (e.g., pointing to) a second page 604 stored in the non-volatile storage device 104.

According to various aspects, a page table entry 608* of the page table 606 may further indicate (e.g., point) to the write FIFO buffer 110 in the case that the write FIFO buffer 110 stores a complete (viz. all packets of an) atomic transaction (e.g., the atomic transaction, TR ID, 20) that includes a data update to the corresponding page the page table entry 608* points to. As detailed herein, at least the start packet 502 of the atomic transaction, TR ID, 20 may indicate the physical address (by Offset 0x16) of the page to which the data update is to be written. Illustratively, the page table 606 is extended to further point to the write FIFO buffer 110. According to various aspects, the page table 606 is extended to directly point to the packets (viz. entries) in the write FIFO buffer 110 that belong to the atomic transaction, TR ID, 20. Illustratively, the page table entry 608* may indicate a respective position of each of the plurality of packets 502, 504, 506, 508 of the atomic transaction, TR ID, 20 within the write FIFO buffer 110.

In some aspects, the memory controller 108 may be configured to adapt the page table entry 608* to point to the (e.g., entries within) the write FIFO buffer 110 in response to receiving the end packet 508 of the atomic transaction, TR ID, 20. In other aspects, the memory controller 108 may be configured to adapt the page table entry 608* each time a packet of the plurality of packets 602, 604, 606, 508 of the atomic transaction, TR ID, 20 is received to point to the received packet.

Extending the page table 606 to point to the write FIFO buffer 110 further allows that, in the case that the host 200 application sends a read request for reading the page data of the first page 602, the memory controller 108 may determine, using the page table entry 608*in the page table 606 that the page data stored in the memory device 102 are not updated yet by the complete atomic transaction, TR ID, 20 and may first merge the corresponding data of the atomic transaction, TR ID, 20 with the page data of the first page 602 and may subsequently provide the merged page data to the host 200 application. Illustratively, the read operation can take complete atomic transactions in the write FIFO buffer 110 into account. This increases the performance further since the opportunistic writing of the data update is ensured in that they can already be provided when receiving a read request to read the page data of the non-updated page.

According to various aspects, the memory controller 108 may be configured to carry out a checkpoint operation. This checkpoint operations illustratively allows to move the checkpointing to hardware behind the memory interface 106 (e.g., the CXL module), thereby significantly increasing the performance of the memory module 100.

The write FIFO buffer 110 may be configured to receive (from the host 200) and store a checkpoint packet. In some aspects, this checkpoint packet may initiate (e.g., trigger) the checkpoint operation. Optionally, the memory module 100 may be configured to receive a checkpoint command via the memory interface 106 from the host 200. As detailed herein, the write FIFO buffer 110 may, for example, received its packets via the CXL.mem protocol. The checkpoint operation may then be initiated (e.g., trigger) by the checkpoint packet and/or the checkpoint command. The checkpoint operation may generate a checkpoint of the memory module 100 (e.g., of the non-volatile storage device 104).

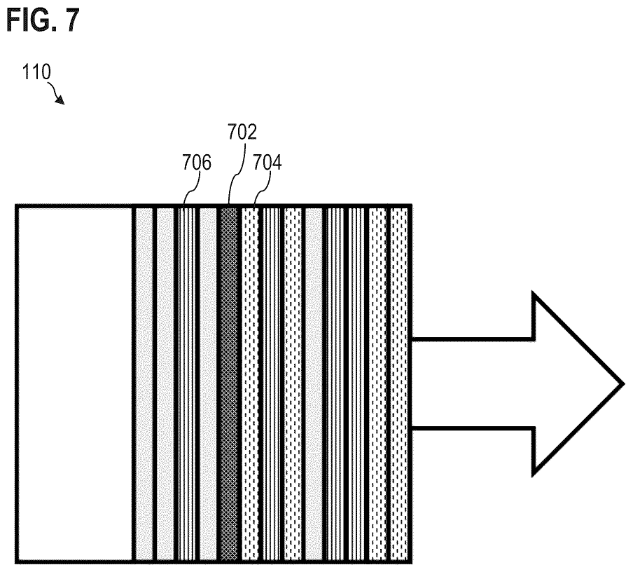

FIG. 7 shows the write FIFO buffer 110 including multiple packets. The multiple packets include the checkpoint packet 702 and multiple packets associated with atomic transactions. In FIG. 7, packets having the same hatching refer to a same atomic transaction. The write FIFO buffer 110 stores the end packet 704 of a first atomic transaction and the end packet 706 of a second atomic transaction.

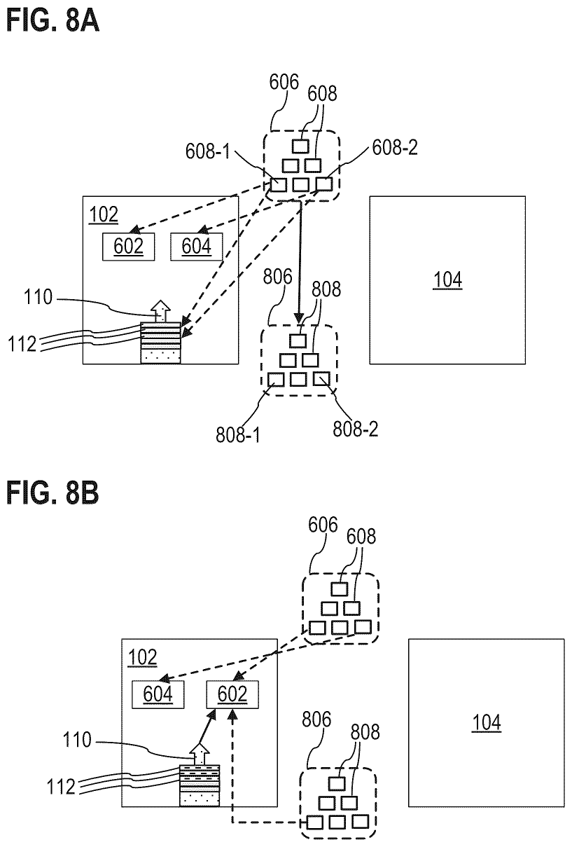

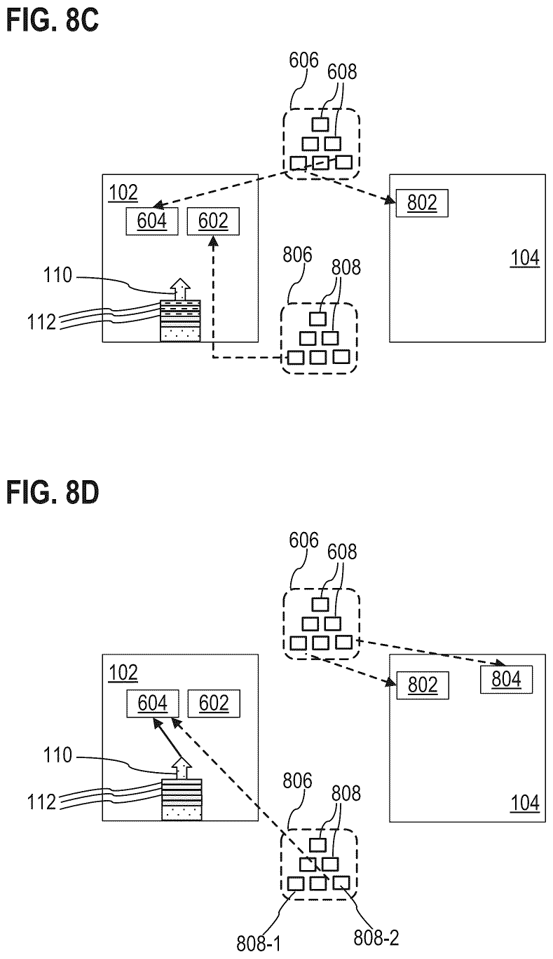

FIG. 8A to FIG. 8D show various aspects of the checkpoint operation for generating a checkpoint, i, (e.g., of the non-volatile storage device 104) according to various aspects. With reference to FIG. 8A, the checkpoint operation may include the generation a page table copy 806 by copying the page table 606. Hence, when generated, the page table entries 808 of the page table copy 806 are the same as the page table entries 608 of the page table 606.

The page table 606 may be associated with the (current) checkpoint, i, and the page table copy 806 may be associated with a next checkpoint, i+1 (or vice versa). In the following, the page table 606 is described to be associated with the (current) checkpoint, i, and the page table copy 806 is described to be associated with the next checkpoint, i+1. It is understood that, since when generated, the page table 606 and the page table copy 806 are the same, the assignment may also be the other way around (viz. the page table copy 806 may be associated with the checkpoint, i, and the page table 606 with the next checkpoint, i+1). To indicate the checkpoint the respective page table 606, 806 is associated with, each page table 606, 806 may include a checkpoint reference (e.g., a checkpoint reference number Ref #) indicating the associated checkpoint (viz. i+1 for the page table copy 806 and i for page table 606 in the present example). Thus, the memory controller 108 may adapt the checkpoint reference of the page table copy 806 to indicate the next checkpoint, i+1. In the example, of the reference number Ref#, the memory controller 108 may increment the number by one (e.g., Ref#=i+1).

As detailed herein, the page table entries of each page table 606, 806 may also point to packets in the write FIFO buffer 110 in the case that there is a complete atomic transaction stored in the write FIFO buffer 110 for updating the corresponding page data of the page table entry.

According to various aspects, in the case that the write FIFO buffer 110 received all packets (e.g., indicated by the end packet) of an atomic transaction prior to the checkpoint packet, the data update represented by the atomic transaction is associated with the (current) checkpoint, i. In the case that the write FIFO buffer 110 received the last packet (e.g., indicated by the end packet) of an atomic transaction after the checkpoint packet, the data update represented by the atomic transaction is associated with the next checkpoint, i+1. Thus, in the example shown in FIG. 7, the first atomic transaction is associated with the (current) checkpoint, i, since its end packet 704 is received prior to the checkpoint packet 702, whereas the second atomic transaction is associated with the next checkpoint, i+1, since its end packet 706 is received after the checkpoint packet 702.

In the example of FIG. 8A, the first atomic transaction may represent a data update to the page data of the first page 602. Hence, the page table 606 may include a first page table entry 608-1 pointing to the first page 602 and to the first atomic transaction in the write FIFO buffer 110. The second atomic transaction may represent a data update to the page data of the second page 604. Hence, the page table 606 may include a second page table entry 608-2 pointing to the second page 604 and to the second atomic transaction in the write FIFO buffer 110.

Illustratively, the write FIFO buffer 110 may store two complete atomic transactions, the first atomic transaction representing a data update to the first page 602 and the second atomic transaction representing a data update to the second page 604. Since the end packet 704 of the first atomic transaction is received prior to the checkpoint packet 702, the data update to the first page 602 by the first atomic transaction is associated with the current checkpoint, i. On the other hand, since the end packet 706 of the second atomic transaction is received after the checkpoint packet 702, the data update to the second page 604 by the second atomic transaction is associated with the next checkpoint, i+1.

Since the page table copy 806 is a copy of the page table 606, the page table copy 806 also includes a first page table entry 808-1 pointing to the first page 602 and to the first atomic transaction in the write FIFO buffer 110, and includes a second page table entry 808-2 pointing to the second page 604 and to the second atomic transaction in the write FIFO buffer 110.

With reference to FIG. 8B, when flushing the first atomic transaction out of the write FIFO buffer 110, new page data may be generated by merging the corresponding data of the first atomic transaction with the page data of the first page 602. With reference to FIG. 8C, for persistent data storage, the new page data of the first page 602 (belonging to the current checkpoint, i) may be copied to a third page 802 in the non-volatile storage device 104. Illustratively, a first page data copy of the page data of the first page 602 is generated. Hence, these new page data in the first page 802 in the non-volatile storage device 104 may belong to the current checkpoint, i. The new page data stored in the first page 602 of the non-volatile memory device 102 may belong to the next checkpoint, i+1. Therefore, the first page table entry 608-1 in the page table 606 may be adapted to point to the third page 802 in the non-volatile storage device 104, whereas the first page table entry 808-1 in the page table copy 806 may be kept to point to the first page 602 in the non-volatile memory device 102.

In contrast to the first atomic transaction, the second atomic transaction does not belong to the current checkpoint, i (but to the next checkpoint, i+1, as detailed above). Therefore, the data represented by the second atomic transaction are only written to the second page 604, once a copy of the second page 604 is stored in the non-volatile storage device 104. For this, with reference to FIG: 8D, a second page data copy may be generated by copying the page data of the second page 604 to a fourth page 804 of the non-volatile storage device 104. Thus, when flushing the second atomic transaction out of the write FIFO buffer 110, the page data of the second page 604 may be copied to the fourth page 804. Since the page data of the page data copy stored in the fourth page 804 belongs to the current checkpoint, i, the second page table entry 608-2 in the page table 606 may be adapted to point to the page copy 804, whereas the second page table entry 808-2 in the page table copy 806 may be kept to point to the second page 604 in the non-volatile memory device 102. Then, the data represented by the second atomic transaction may be merged with the page data of the second page 604.

Illustratively, generating the (current) checkpoint, i, may in either case include generating copying the page data to the non-volatile storage device 104. However, in the case that a complete atomic transaction stored in the write FIFO buffer 110 belongs to the (current) checkpoint, i, the data represented by the complete atomic transaction are merged with the page data prior to copying them. In the case that a complete atomic transaction stored in the write FIFO buffer 110 belongs to the next checkpoint, i+1, the page data associated with the current checkpoint are copied first and the page table is adapted to point to the copy prior to merging the data represented by the complete atomic transaction with the page data at the original physical address.

Generating the (current) checkpoint, i, may therefore include writing the data of all atomic transactions that were stored in the write FIFO buffer 110 prior to the reception of the checkpoint packet 702 to the corresponding page and to write the page data of all pages that are stored in the memory device 102 to the non-volatile storage device 104 (for persistent data storage).

Hence, once the page data associated with the current checkpoint, i, are copied to (another) physical address of the non-volatile storage device 104, the original page data belong to the next checkpoint, i+1, only and can be adapted by atomic transactions received via the write FIFO buffer 110. To know, whether the page data of a page to which a newly received atomic transaction wants to write belongs to the next checkpoint, i+1, only or has to be copied to the non-volatile storage device 104 first, each page table entry of each page table 606, 806 may further indicate (e.g., by a checkpoint identifier) indicating this. Thus, the checkpoint identifier may indicate whether the corresponding page is associated with the checkpoint or a next checkpoint. For example, each page table entry may include the checkpoint identifier indicating checkpoint, i, in the case that the page data were not (yet) checkpointed (e.g., copied, e.g., stored) by the copy-before-write operation and indicating the next checkpoint, i+1, in the case that the page data were checkpointed by the copy-before-write operation. Thus, when initially generated, the page table entries of the page table copy 806 may all indicated the checkpoint, i, since there was no copy-before-write operation carried out yet.

According to various aspects, the copy-before-write operation may be carried out in the case that the atomic transaction flushed out of the write FIFO buffer 110 is associated with a checkpoint different from the checkpoint indicated by the checkpoint identifier. Thus, since initially all page table entries indicate the current checkpoint, i, no copy-before-write operation is carried out when flushing the first atomic transaction out of the write FIFO buffer 110. However, when receiving a further atomic transaction that also wants to write data to the first page 602, this further atomic transaction will be associated with the next checkpoint, i+1, and since the first page table entry 808-1 of the page table copy 806 still indicates the current checkpoint, i, the copy-before-write operation will be triggered to generate the copy of the page data first and store the copy persistently in the non-volatile storage device 104. Thus, when carrying out the copy-before-write operation, the corresponding page table entry of the page table 606 is adapted to point to the page storing the page data copy in the non-volatile storage device 104 whereas the corresponding page table entry of the page table copy 806 is kept to point to the original page table and its checkpoint identifier is adapted to indicate the next checkpoint, i+1.

Hence, for all atomic transactions that were completed after reception of the checkpoint packet 702 (thus, whose end packet was received after the checkpoint packet 702), the memory controller 108 may only adapt the corresponding page table entry of the page table copy 806 to point to the plurality of packets of those atomic transactions since these atomic transactions are associated with the next checkpoint, i+1.

According to various aspects, a page table entry may indicate whether the copy-before-write operation has been carried out by the checkpoint identifier which may indicate to which checkpoint (i or i+1) the page table entry belongs to.

Whenever the write FIFO buffer 110 stores a complete atomic transaction associated with the next checkpoint, i+1, the memory controller 108 may determine whether the page data of the page to which the complete atomic transaction wants to write to are associated with the current checkpoint, i, or the next checkpoint, i+1 using the checkpoint identifier. Illustratively, the checkpoint identifier may indicate whether the page data of the page were checkpointed by the copy-before-write operation or not. This ensures that the page data associated with the current checkpoint are not overwritten, but persistently stored in the non-volatile storage device 104.

The copy-before-write operation may include the generation of a page data copy by copying the page data of a page associated with the current checkpoint to a new physical address of the non-volatile storage device 104 and adapting the corresponding page table entry in the page table to point to the new physical address. The page table entry in the page table copy 806 is not updated. Illustratively, whenever page data of a page that belongs to the current checkpoint (which may after the checkpoint operation referred to as prior checkpoint) are to be updated (by an atomic transaction associated with the next checkpoint), the page data are first copied to another location on the non-volatile storage device 104 and are then updated, thereby ensuring that the page data of the current checkpoint are not changed.

It is understood that the memory module 100 does not have to wait with carrying out the copy-before-write operation until an atomic transaction is flushed, but rather may carry out the copy-before-write operation for all pages after receiving the checkpoint packet 702. Since even full atomic transactions can be stored in the write FIFO buffer 110 and written opportunistically, this provides time to carry out the copy-before-write operation. Illustratively, the host 200 application does not have to pause during checkpoint generation but can continue to write data to the memory module 100. As detailed herein, the host 200 application can also read data including the data of full atomic transactions since the page tables 606, 806 may point to the write FIFO buffer 110.

Although various aspects of the checkpointing operation are described with reference pages of the non-volatile memory device 102, it is understood that this serves for illustration and that the same copy-before-write operation is carried out for the pages of the non-volatile storage device 104. With regard to this, it is noted that the memory mapping (MMAP) detailed herein may not differentiate between pages having a physical address of the non-volatile memory device 102 and pages having a physical address of the non-volatile storage device 104, but providing a common physical address space (via the logical addresses).

Illustratively, the checkpointing detailed herein allows to move the checkpointing background activities from software to hardware, thereby speeding up the (storage) checkpointing. Herein, the initiation of the checkpointing (e.g., by reception of the checkpoint command and/or the checkpoint packet), the data merging during and after checkpoint generation, etc. are carried out in hardware by the memory controller 108. Also, all address resolution tasks related to the physical addresses are handled by the memory controller 108.

As an exemplary application case, the memory module 100 may be part of an In-memory database management system (DBMS). In-memory database management systems rely on the direct storage of data within the memory device 102, which provides rapid data access and high throughput. However, this usually relies on volatile memory, thereby presenting a challenge to data durability, as the system may crash or restart unexpectedly, potentially leading to the loss of all in-memory data. To mitigate this risk, periodic snapshots (viz. checkpoints) may be carried out by capturing a complete and consistent copy of the in-memory state and storing it persistently (in the non-volatile storage device 104). These snapshots allow the database to recover swiftly without significant data loss, thereby preserving data integrity and reducing downtime. However, frequent snapshotting can strain storage and network resources, as well as impact system performance. Efficiently managing snapshots is critical for ensuring both the reliability and availability of in-memory databases in production environments.

Commonly, in-memory databases create a transactional log of the write operations to persist the data. When creating the checkpoint (viz. snapshot), this transaction log may be flushed (viz. emptied). The input/output is handled in software by the operating system (OS). Thus, checkpointing overhead lowers the performance of in-memory DBMS mainly due to the limitations that all is done in software. When carrying the checkpoint operation, the database operation halts until the checkpoint operation is done.

Thus, using the checkpoint operation described herein in combination with the memory module 100, the checkpoint operation is moved to hardware, thereby increasing the performance of the in-memory DBMS significantly. Further, when using the checkpoint operation described herein in combination with the memory module 100, the database operation has not to be paused during the checkpoint operation. Thus, besides performance improvement, this further allows to generate checkpoints more frequently, thereby improving data reliability as well.

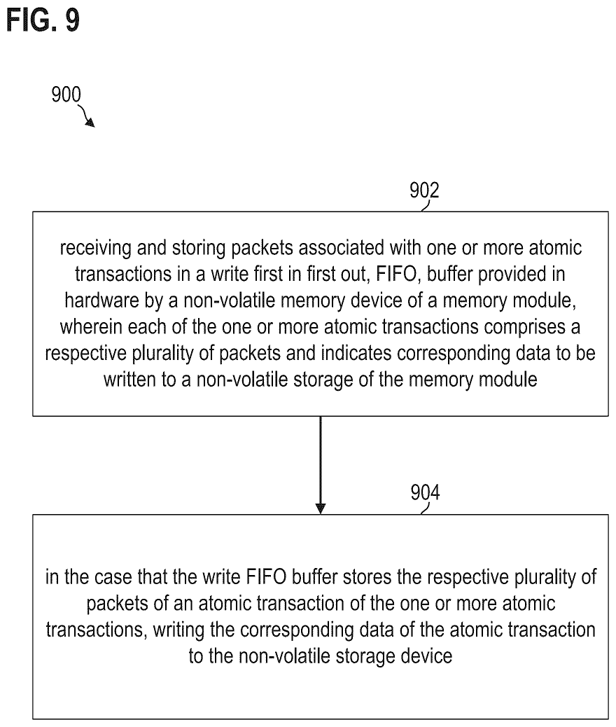

FIG. 9 shows a flow diagram of a method 900 for writing data to a memory module (e.g., the memory module 100) according to various aspects.

The method 900 may include (in 902) receiving and storing packets associated with one or more atomic transactions in a write first in first out, FIFO, buffer provided in hardware by a (byte-addressable) non-volatile memory device of the memory module. Each of the one or more atomic transactions may include a respective plurality of packets and indicates corresponding data to be written to the memory module.

The method 900 may include (in 904), in the case that the write FIFO buffer stores the respective plurality of packets of an atomic transaction of the one or more atomic transactions, writing the corresponding data of the atomic transaction to the memory module.

It may be intended that aspects described in relation to one or more of the methods may apply also to the memory device, and vice versa. For example, a method may include an execution of one or more functions described with reference to the memory device. For example, the memory controller 108 of the memory module 100 may be configured to carry out one or more aspects described herein.

In the following, various examples are provided that may include one or more aspects described above with reference to the memory module 100, the memory controller 108, and to the methods described herein. It may be intended that aspects described in relation to one or more of the methods may apply also to the memory device, and vice versa.
Example 1 is a (computer-readable) memory module including: a memory interface; a non-volatile (e.g., flash) storage device (short: non-volatile storage) for persistently storing data; a (byte-addressable) non-volatile memory device (short: non-volatile memory) providing a write first in first out, FIFO, buffer in hardware, the write FIFO buffer being configured to receive, (from a processing unit) via the memory interface, and to store packets associated with one or more atomic transactions, wherein each of the one or more atomic transactions includes a respective plurality of packets and indicates corresponding data to be written to the memory module; a memory controller configured to write the corresponding data of an atomic transaction of the one or more atomic transactions to the memory module (e.g., to the non-volatile memory device and/or the non-volatile storage device depending on the physical address to which the corresponding data are to be written) in the case that the write FIFO buffer stores the respective plurality of packets of the atomic transaction.

This allows to ensure data coherency without any access locking on the non-volatile storage. According to various aspects, the data are only written to the non-volatile storage once they are coherent, viz. once a complete atomic transaction is received. Further, to write (e.g., merge) the data, no further interaction with a (central) processing unit is required, but the write (e.g., merge) operation is carried out completely in hardware by back-pressuring the memory controller. This improves the performance of the memory module.
In Example 2, the memory device of Example 1 can optionally further include: one or more processors configured to, in response to receiving via the memory interface a packet that is associated with a first atomic transaction and that indicates a first thread and a first physical address of the memory module to which the corresponding data of the first atomic transaction are to be written, prevent the packet from being stored in the write FIFO buffer in the case that the first thread has no write permission to the first physical address.
In Example 3, the memory device of Example 1 or 2 can optionally further include: one or more processors configured to implement an operating system allowing a processing unit to register a thread to have write permission to one or more corresponding physical addresses of the memory module; wherein the memory controller is configured to, in response to receiving via the memory interface a packet that is associated with a first atomic transaction and that indicates a first thread and a first physical address of the memory module to which the corresponding data of the first atomic transaction are to be written, prevent the packet from being stored in the write FIFO buffer in the case that the first thread has no write permission to the first physical address.

Examples 2 and 3 both ensure thread synchronization. Example 3 allows to further improve the performance of the memory device by also moving the thread synchronization into hardware (since the memory controller ensures thread synchronization by only allowing packets of permitted threads to enter the write FIFO buffer).
In Example 4, the subject matter of any one of Examples 1 to 3 can optionally include that the memory interface is a Compute Express Link (CXL) interface, wherein the write FIFO buffer is addressable by at least one predefined physical address via the Compute Express Link Memory (CXL.mem) protocol.

The CXL.mem protocol allows a (host) processing unit to directly access the write FIFO buffer of the non-volatile memory device using the by at least one predefined physical address.
In Example 5, the subject matter of any one of Examples 1 to 4 can optionally include that the respective plurality of packets of a respective atomic transaction of each of the one or more atomic transactions includes: a start packet indicating (a start of the atomic transaction and) a thread associated with the atomic transaction and a physical address of the memory module to which the corresponding data of the atomic transaction are to be written; and a plurality of data packets including the corresponding data of the atomic transaction (with each data packet of the plurality of data packets including part of the corresponding data); and, optionally, an end packet indicating reception of all packets of the respective plurality of packets of the atomic transaction.
In Example 6, the subject matter of any one of Examples 1 to 5 can optionally include that the respective plurality of packets of a respective atomic transaction of each of the one or more atomic transactions includes an end packet indicating reception of all packets of the respective plurality of packets; and wherein the memory controller is configured to, after (e.g., in response to) receiving the end packet of the atomic transaction via the memory interface, (e.g., opportunistically) write the corresponding data of the atomic transaction to the memory module.

Illustratively, the end packet may trigger the memory controller to (e.g., opportunistically) initiate the writing of the corresponding data to the memory module. This allows to improve the performance of the memory module since the memory controller does not have to scan the packets in the write FIFO buffer all the time in order to determine whether all data packets of (viz. a complete) atomic transaction is received and stored in the write FIFO buffer.
In Example 7, the subject matter of any one of Examples 1 to 6 can optionally include that at least the packet of the respective plurality of packets that is stored first in the write FIFO buffer indicates a namespace bijectively assigned to a corresponding memory portion of the memory module (e.g., the non-volatile storage device and/or the non-volatile memory device).

Using different namespaces allows to provide multi-tenancy (viz. multiple host applications to access the memory module).
In Example 8, the subject matter of any one of Examples 1 to 7 can optionally include that the memory controller is configured to, in the case that the write FIFO buffer stores the respective plurality of packets of the atomic transaction, sort the packets stored in the write FIFO buffer to (coalesce and) output the respective plurality of packets first for writing the corresponding data of the atomic transaction to the memory module.
In Example 9, the subject matter of any one of Examples 1 to 8 can optionally include that the non-volatile memory is or includes at least one of: a remanent-polarizable non-volatile random-access memory (e.g., a ferroelectric non-volatile random-access memory, FeNVRAM), a magnetoresistive random-access memory (MRAM), or a resistive random-access memory (RRAM).
In Example 10, the subject matter of any one of Examples 1 to 9 can optionally include that the atomic transaction represents a data update to page data of a respective page stored in the non-volatile storage device of the memory module; and wherein the memory controller is configured to write the corresponding data of the atomic transaction to the non-volatile storage device by: copying the page data of the respective page to the non-volatile memory device, generating new page data by merging the corresponding data with the page data stored in the non-volatile memory device, and writing the new page data to the respective page in the non-volatile storage device.
In Example 11, the subject matter of any one of Examples 1 to 10 can optionally include that the non-volatile memory device and/or the non-volatile storage device are configured to store a page table including a respective page table entry for each page of a plurality of pages (e.g., being associated with a corresponding namespace) stored in the non-volatile memory device and/or the non-volatile storage device, the respective page table entry of a respective page of the plurality of pages indicating (a respective logical (e.g., virtual) address and) a respective physical address; wherein the respective plurality of packets of a respective atomic transaction of each of the one or more atomic transactions includes an (e.g., the) end packet indicating reception of all packets of the respective plurality of packets and wherein the atomic transaction represents a data update to page data of a respective page of the plurality of pages; wherein the memory controller is configured to, in response to receiving the end packet of the atomic transaction via the memory interface, adapt the respective page table entry of the respective page to indicate that the write FIFO buffer stores the atomic transaction for updating the page data of the respective page.
In Example 12, the subject matter of Example 11 can optionally include that the memory controller is configured to, in response to receiving the end packet of the atomic transaction via the memory interface, adapt the respective page table entry to indicate a respective position of each of the respective plurality of packets of the atomic transaction within the write FIFO buffer.
In Example 13, the subject matter of Example 11 or 12 can optionally include that the memory controller is configured to, in response to receiving, from a processing unit, via the memory interface a read request for providing page data of a page of the plurality of pages: in the case that the respective page table entry of the respective page indicates that the write FIFO buffer stores an (complete) atomic transaction for updating the respective page, merge the corresponding data of the atomic transaction with the page data of the respective page prior to providing them to the processing unit via the memory interface.

This ensures that already at the time a complete atomic transaction is stored in the write FIFO buffer the data that are to be written by this atomic transaction can be provided when the associated page is read. With this, there is no time pressure on writing the data of the atomic transaction to the memory module, but the data can be written opportunistically, thereby further improving the performance of the memory module.
In Example 14, the subject matter of any one of Examples 11 to 13 can optionally include that the write FIFO buffer is further configured to receive, (from the processing unit) via the memory interface, and to store a checkpoint packet initiating a checkpoint operation for generating a checkpoint of the memory module, the checkpoint operation including: generating a page table copy by copying the page table (the page table copy being associated with a next checkpoint of the memory module); for each page table entry of the page table: in the case that the page table entry of a respective page indicates that the write FIFO buffer stores the respective plurality of packets of at least one first atomic transaction and that the write FIFO received the respective plurality of packets of the at least one first atomic transaction prior to the checkpoint packet, merging the corresponding data of the at least one first atomic transaction with the page data of the respective page.

This ensures that in the case that all complete atomic transactions in the write FIFO buffer which are received prior to the checkpoint packet are part of the generated checkpoint (and not only of the next checkpoint).
In Example 15, the subject matter of Example 14 can optionally include that the checkpoint operation further includes: in the case that the page table entry of a respective page indicates that the write FIFO buffer stores the respective plurality of packets of at least one second atomic transaction and that the write FIFO received at least one packet of the respective plurality of packets of the at least one second atomic transaction after the checkpoint packet, generating a page data copy by copying the page data of the respective page to a different physical address of the non-volatile storage device, updating the page table entry of the page table (but not of the page table copy) to indicate the different physical address, and, subsequently, merging the corresponding data of the at least one second atomic transaction with the page data of the respective page (at the initial physical address).

This ensures that in the case that an atomic transaction in the write FIFO buffer was completed after reception of the checkpoint packet is not part of the generated checkpoint (but of the next checkpoint).
In Example 16, the subject matter of Example 14 or 15 can optionally include that each page table entry of the page table copy (e.g., includes a checkpoint identifier that) indicates whether the respective page is associated with the checkpoint or a next checkpoint; wherein in the case that the write FIFO buffer stores the respective plurality of packets of a respective atomic transaction that represents a data update to page data of the respective page and in the case that the page table entry of the respective page (of the page table copy) indicates that the respective page is associated with the checkpoint, the memory controller is configured to carry out a copy-before-write operation to write the corresponding data of the atomic transaction to the memory module, the copy-before-write operation including: generating a page data copy by copying the page data of the respective page to a different physical address of the non-volatile storage device; subsequently, merging the corresponding data of the atomic transaction with the page data; and updating the checkpoint identifier of the page table entry of the respective page to indicate that the respective page is associated with the next checkpoint.

Illustratively, according to the copy-before-write operation, whenever page data of a page that belongs to a prior checkpoint are to be updated, the page data are first copied to another location on the non-volatile storage device and afterwards the page data at the initial location are updated, thereby ensuring that the page data of the prior checkpoint are not changed.
Example 17 is an In-memory database management system (DBMS) including the memory module according to any one of Examples 14 to 16.
Example 18 is a method for writing data to a memory module including a non-volatile memory device and a non-volatile storage device, the method including: receiving and storing packets associated with one or more atomic transactions in a write first in first out, FIFO, buffer provided in hardware by the (byte-addressable) non-volatile memory device, wherein each of the one or more atomic transactions includes a respective plurality of packets and indicates corresponding data to be written to the memory module (e.g., to the non-volatile storage device of the memory module); in the case that the write FIFO buffer stores the respective plurality of packets of an atomic transaction of the one or more atomic transactions, writing the corresponding data of the atomic transaction to the memory module.
In Example 19, the method of Example 18 can optionally further include: generating access credentials by registering a thread to have write permission to one or more corresponding physical addresses of the memory module (e.g., including physical addresses of a non-volatile storage device); wherein receiving and storing packets associated with the one or more atomic transactions includes: receiving a first packet of the plurality of packets of a respective atomic transaction of the one or more atomic transactions, the first packet including access credentials, a physical address of the memory module to which the corresponding data of the atomic transaction are to be written, and a thread identifier; and in the case that the access credentials indicate write permission of a thread associated with the thread identifier to the physical address, storing the first packet and optionally further subsequent packets of the plurality of packets of the atomic transaction in the write FIFO buffer.
In Example 20, the subject matter of Example 18 or 19 can optionally include that the packets are received via a memory interface, the memory interface being a Compute Express Link (CXL) interface, wherein the write FIFO buffer is addressable by at least one predefined physical address via the Compute Express Link Memory (CXL.mem) protocol.
In Example 21, the subject matter of any one of Examples 18 to 20 can optionally include that the respective plurality of packets of a respective atomic transaction of each of the one or more atomic transactions includes: a start packet indicating (a start of the atomic transaction and) a thread associated with the atomic transaction and a physical address of the memory module to which the corresponding data of the atomic transaction are to be written; and a plurality of data packets including the corresponding data of the atomic transaction (with each data packet of the plurality of data packets including part of the corresponding data); and, optionally, an end packet indicating reception of all packets of the respective plurality of packets of the atomic transaction.
In Example 22, the subject matter of any one of Examples 18 to 21 can optionally include that the respective plurality of packets of a respective atomic transaction of each of the one or more atomic transactions includes an end packet indicating reception of all packets of the respective plurality of packets; and wherein the method includes: after (e.g., in response to) receiving the end packet of the atomic transaction, (e.g., opportunistically) writing the corresponding data of the atomic transaction to the memory module.
In Example 23, the subject matter of any one of Examples 18 to 22 can optionally include that at least the packet of the respective plurality of packets that is stored first in the write FIFO buffer indicates a namespace bijectively assigned to a corresponding memory portion of the non-volatile storage.
In Example 24, the method of any one of Examples 18 to 23 can optionally further include: in the case that the write FIFO buffer stores the respective plurality of packets of an atomic transaction of the one or more atomic transactions, sorting the packets stored in the write FIFO buffer to (coalesce and) output the respective plurality of packets first prior to writing the corresponding data of the atomic transaction to the memory module.
In Example 25, the subject matter of any one of Examples 18 to 24 can optionally include that the non-volatile memory is a remanent-polarizable non-volatile random-access memory (e.g., a ferroelectric non-volatile memory, FeNVRAM), a magnetoresistive random-access memory (MRAM), or a resistive random-access memory (RRAM).
In Example 26, the subject matter of any one of Examples 18 to 25 can optionally include that the atomic transaction represents a data update to page data of a respective page stored in the non-volatile storage device of the memory module; and wherein writing the corresponding data of the atomic transaction to the non-volatile storage device includes: copying the page data of the respective page to the non-volatile memory device, generating new page data by merging the corresponding data with the page data stored in the non-volatile memory device, and writing the new page data to the respective page in the non-volatile storage device.
In Example 27, the subject matter of any one of Examples 18 to 26 can optionally include that the respective plurality of packets of a respective atomic transaction of each of the one or more atomic transactions includes an (e.g., the) end packet indicating reception of all packets of the respective plurality of packets and wherein the atomic transaction represents a data update to page data of a page of a plurality of pages, wherein a page table includes a respective page table entry (e.g., being associated with a corresponding namespace) for each page of the plurality of pages; wherein the method further includes: in response to receiving the end packet of the atomic transaction, adapting the respective page table entry of the page to indicate that the write FIFO buffer stores the atomic transaction for updating the page data of the page.
In Example 28, the subject matter of Example 27 can optionally include that the respective page table entry is further adapted to indicate a respective position of each of the respective plurality of packets of the atomic transaction within the write FIFO buffer.
In Example 29, the method of Example 27 or 28 can optionally further include: in response to receiving, from a processing unit, a read request for providing page data of a page of the plurality of pages, in the case that the respective page table entry of the respective page indicates that the write FIFO buffer stores an (complete) atomic transaction for updating the respective page, merging the corresponding data of the atomic transaction with the page data of the respective page prior to providing them to the processing unit.
In Example 30, the method of any one of Examples 27 to 29 can optionally further include: in response to storing a checkpoint packet in the write FIFO buffer, initiating a checkpoint operation for generating a checkpoint of the memory module, the checkpoint operation including: generating a page table copy by copying the page table (the page table copy being associated with a next checkpoint of the memory module); for each page table entry of the page table: in the case that the page table entry of a respective page indicates that the write FIFO buffer stores the respective plurality of packets of at least one first atomic transaction and that the write FIFO received the respective plurality of packets of the at least one first atomic transaction prior to the checkpoint packet, merging the corresponding data of the at least one first atomic transaction with the page data of the respective page.
In Example 31, the subject matter of Example 30 can optionally include that the checkpoint operation further includes: in the case that the page table entry of a respective page indicates that the write FIFO buffer stores the respective plurality of packets of at least one second atomic transaction and that the write FIFO received at least one packet of the respective plurality of packets of the at least one second atomic transaction after the checkpoint packet, generating a page data copy by copying the page data of the respective page to a different physical address of the non-volatile storage device, updating the page table entry of the page table (but not of the page table copy) to indicate the different physical address, and (subsequently) merging the corresponding data of the at least one second atomic transaction with the page data.
In Example 32, the subject matter of Example 30 or 31 can optionally include that each page table entry of the page table copy includes a checkpoint identifier indicating whether the respective page is associated with the checkpoint or a next checkpoint; wherein the method further includes, in the case that the write FIFO buffer stores the respective plurality of packets of a respective atomic transaction that represents a data update to page data of the respective page and in the case that the checkpoint identifier of the page table entry of the respective page (of the page table copy) indicates that the respective page is associated with the checkpoint, carrying out a copy-before-write operation to write the corresponding data of the atomic transaction to the memory module, the copy-before-write operation including: generating a page data copy by copying the page data of the respective page to a different physical address of the non-volatile storage device; subsequently, merging the corresponding data of the atomic transaction with the page data; and updating the checkpoint identifier of the page table entry of the respective page to indicate that the respective page is associated with the next checkpoint.

The term “connected” may be used herein with respect to nodes, terminals, integrated circuit elements, and the like, to mean electrically connected, which may include a direct connection or an indirect connection, wherein an indirect connection may only include additional structures in the current path that do not influence the substantial functioning of the described circuit or device. The term “electrically conductively connected” that is used herein to describe an electrical connection between one or more terminals, nodes, regions, contacts, etc., may be understood as an electrically conductive connection with, for example, ohmic behavior, e.g., provided by a metal or degenerate semiconductor in absence of p-n junctions in the current path. The term “electrically conductively connected” may be also referred to as “galvanically connected”.

The term “coupled to” used herein with reference to components of a memory device may be understood in that the components are directly or indirectly communicatively coupled to one another.

The terms “at least one” and “one or more” may be understood to include any integer number greater than or equal to one, i.e. one, two, three, four, [ . . . ], etc. The term “a plurality” or “a multiplicity” may be understood to include any integer number greater than or equal to two, i.e. two, three, four, five, [ . . . ], etc. The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The phrase that an element or a group of elements “includes” another element or another group of elements may be used herein to mean that the other element or other group of elements may be part of the element or the group of elements or that the element or the group of elements may be configured or formed as the other element or the other group of elements (e.g., the element may be the other element).

The phrase “unambiguously assigned” may be used herein to mean a one-to-one-assignment (e.g., allocation, e.g., correspondence) or a bijective assignment. As an example, a first element being unambiguously assigned to a second element may include that the second element is unambiguously assigned to the first element. As another example, a first group of elements being unambiguously assigned to a second group of element may include that each element of the first group of elements is unambiguously assigned to a corresponding element of the second group of elements and that that corresponding element of the second group of elements is unambiguously assigned to the element of the first group of elements.

The term “page”, as used herein, may refer to a memory/storage region that can store data having the size of one page (short: page size).

The term “processor” as used herein may be understood as any kind of technological entity that allows handling of data. The data may be handled according to one or more specific functions that the processor may execute. Further, a processor as used herein may be understood as any kind of circuit, e.g., any kind of analog or digital circuit. A processor may thus be or include an analog circuit, digital circuit, mixed-signal circuit, logic circuit (e.g., a hard-wired logic circuit or a programmable logic circuit), microprocessor (for example a Complex Instruction Set Computer (CISC) processor or a Reduced Instruction Set Computer (RISC) processor), Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. A “processor” may also be a logic-implementing entity executing software, for example any kind of computer program, for example a computer program using a virtual machine code such as for example Java. A “processor” as used herein may also include any kind of cloud-based processing system that allows handling of data in a distributed manner, e.g. with a plurality of logic-implementing entities communicatively coupled with one another (e.g. over the internet) and each assigned to handling the data or part of the data. By way of illustration, an application running on a server and the server can also be a “processor”. Any other kind of implementation of the respective functions, which will be described below in further detail, may also be understood as a processor. It is understood that any two (or more) of the processors detailed herein may be realized as a single entity with equivalent functionality or the like, and conversely that any single processor detailed herein may be realized as two (or more) separate entities with equivalent functionality or the like.

Various aspects detailed herein refer to a “database”. In general, a database may be an organized collection of data. For this purpose, the database may include one or more tables. Each table of the one or more tables may include (e.g., store) dataset (or more datasets) in an organized manner. A database (e.g., the organized collection of data, the tables or other database objects, operations which can be applied on the objects (e.g., a table) of the database, etc.) may be configured in accordance with a corresponding “database management system” (DBMS). Hence, a DBMS may be employed in order to implement a database.

It is noted that one or more functions described herein with reference to a memory device may be accordingly part of a method, e.g., part of a method for operating a memory device. Vice versa, one or more functions described herein with reference to a method, e.g., with reference to a method for operating a memory device, may be implemented accordingly in a device or in a part of a device, for example, by a memory controller.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

What is claimed is:

1. A memory module, comprising:
a memory interface;
a non-volatile storage device for persistently storing data;
a non-volatile memory device providing a write first in first out (FIFO) buffer in hardware, the write FIFO buffer being configured to receive, via the memory interface, and to store packets associated with one or more atomic transactions, wherein each of the one or more atomic transactions comprises a respective plurality of packets and indicates corresponding data to be written to the memory module;
a memory controller configured to write the corresponding data of an atomic transaction of the one or more atomic transactions to the memory module in the case that the write FIFO buffer stores the respective plurality of packets of the atomic transaction.

2. The memory module according to claim 1, further comprising:
one or more processors configured to implement an operating system allowing a processing unit to register a thread to have write permission to one or more corresponding physical addresses of the memory module;
wherein the memory controller is configured to, in response to receiving via the memory interface a packet that is associated with a first atomic transaction and that indicates a first thread and a first physical address of the memory module to which the corresponding data of the first atomic transaction are to be written, prevent the packet from being stored in the write FIFO buffer in the case that the first thread has no write permission to the first physical address.

3. The memory module according to claim 1,
wherein the memory interface is a Compute Express Link interface, wherein the write FIFO buffer is addressable by at least one predefined physical address via the Compute Express Link Memory protocol.

4. The memory module according to claim 1,
wherein the respective plurality of packets of a respective atomic transaction of each of the one or more atomic transactions comprises:
a start packet indicating a thread associated with the atomic transaction and a physical address of the memory module to which the corresponding data of the atomic transaction are to be written; and
a plurality of data packets including the corresponding data of the atomic transaction; and, optionally,
an end packet indicating reception of all packets of the respective plurality of packets of the atomic transaction.

5. The memory module according to claim 1,
wherein the respective plurality of packets of a respective atomic transaction of each of the one or more atomic transactions comprises an end packet indicating reception of all packets of the respective plurality of packets; and
wherein the memory controller is configured to, after receiving the end packet of the atomic transaction via the memory interface, write the corresponding data of the atomic transaction to the memory module.

6. The memory module according to claim 1,
wherein at least the packet of the respective plurality of packets that is stored first in the write FIFO buffer indicates a namespace bijectively assigned to a corresponding memory portion of the memory module.

7. The memory module according to claim 1,
wherein the memory controller is further configured to, in the case that the write FIFO buffer stores the respective plurality of packets of the atomic transaction, sort the packets stored in the write FIFO buffer to output the respective plurality of packets first for writing the corresponding data of the atomic transaction to the memory module.

8. The memory module according to claim 1,
wherein the non-volatile memory device includes at least one of: a remanent-polarizable non-volatile random-access memory, a magnetoresistive random-access memory, a resistive random-access memory, and combinations thereof.

9. The memory module according to claim 1,
wherein the atomic transaction represents a data update to page data of a respective page stored in the non-volatile storage device of the memory module; and
wherein the memory controller is further configured to write the corresponding data of the atomic transaction to the non-volatile storage device by:
copying the page data of the respective page to the non-volatile memory device,
generating new page data by merging the corresponding data with the page data stored in the non-volatile memory device, and
writing the new page data to the respective page in the non-volatile storage device.

10. The memory module according to claim 1,
wherein the non-volatile memory device and/or the non-volatile storage device are configured to store a page table comprising a respective page table entry for each page of a plurality of pages stored in the non-volatile memory device and/or the non-volatile storage device, the respective page table entry of a respective page of the plurality of pages indicating a respective physical address;
wherein the respective plurality of packets of a respective atomic transaction of each of the one or more atomic transactions comprises an end packet indicating reception of all packets of the respective plurality of packets and wherein the atomic transaction represents a data update to page data of a respective page of the plurality of pages;
wherein the memory controller is further configured to, in response to receiving the end packet of the atomic transaction via the memory interface, adapt the respective page table entry of the respective page to indicate that the write FIFO buffer stores the atomic transaction for updating the page data of the respective page.

11. The memory module according to claim 10,
wherein the memory controller is further configured to, in response to receiving the end packet of the atomic transaction via the memory interface, adapt the respective page table entry to indicate a respective position of each of the respective plurality of packets of the atomic transaction within the write FIFO buffer.

12. The memory module according to claim 10,
wherein the memory controller is further configured to, in response to receiving, from a processing unit via the memory interface, a read request for providing page data of a page of the plurality of pages:
in the case that the respective page table entry of the respective page indicates that the write FIFO buffer stores an atomic transaction for updating the respective page, merge the corresponding data of the atomic transaction with the page data of the respective page prior to providing them to the processing unit via the memory interface.

13. The memory module according to claim 10,
wherein the write FIFO buffer is further configured to receive, via the memory interface, and to store a checkpoint packet initiating a checkpoint operation for generating a checkpoint of the memory module, the checkpoint operation comprising:
generating a page table copy by copying the page table;
for each page table entry of the page table: in the case that the page table entry of a respective page indicates that the write FIFO buffer stores the respective plurality of packets of at least one first atomic transaction and that the write FIFO received the respective plurality of packets of the at least one first atomic transaction prior to the checkpoint packet, merging the corresponding data of the at least one first atomic transaction with the page data of the respective page.

14. The memory module according to claim 13,
wherein, in the case that the page table entry of a respective page indicates that the write FIFO buffer stores the respective plurality of packets of at least one second atomic transaction and that the write FIFO received at least one packet of the respective plurality of packets of the at least one second atomic transaction after the checkpoint packet, the checkpoint operation further comprises:
generating a page data copy by copying the page data of the respective page to a different physical address of the non-volatile storage device,
updating the page table entry of the page table to indicate the different physical address, and, subsequently,
merging the corresponding data of the at least one second atomic transaction with the page data.

15. The memory module according to claim 13,
wherein each page table entry of the page table copy indicates whether the respective page is associated with the checkpoint or a next checkpoint;
wherein in the case that the write FIFO buffer stores the respective plurality of packets of a respective atomic transaction that represents a data update to page data of the respective page and in the case that the page table entry of the respective page indicates that the respective page is associated with the checkpoint, the memory controller is further configured to carry out a copy-before-write operation to write the corresponding data of the atomic transaction to the memory module, the copy-before-write operation comprising:
generating a page data copy by copying the page data of the respective page to a different physical address of the non-volatile storage device;
subsequently, merging the corresponding data of the atomic transaction with the page data; and
updating the checkpoint identifier of the page table entry of the respective page to indicate that the respective page is associated with the next checkpoint.

16. A method for writing data to a memory module including a non-volatile memory
device and a non-volatile storage device, the method comprising:
receiving and storing packets associated with one or more atomic transactions in a write first in first out, FIFO, buffer provided in hardware by the non-volatile memory device, wherein each of the one or more atomic transactions comprises a respective plurality of packets and indicates corresponding data to be written to the memory module;
in the case that the write FIFO buffer stores the respective plurality of packets of an atomic transaction of the one or more atomic transactions, writing the corresponding data of the atomic transaction to the memory module.

17. The method according to claim 16, further comprising:
generating access credentials by registering a thread to have write permission to one or more corresponding physical addresses of the memory module;
wherein receiving and storing packets associated with the one or more atomic transactions comprises:
receiving a first packet of the plurality of packets of a respective atomic transaction of the one or more atomic transactions, the first packet comprising access credentials, a physical address of the memory module to which the corresponding data of the atomic transaction are to be written, and a thread identifier; and
in the case that the access credentials indicate write permission of a thread associated with the thread identifier to the physical address, storing the first packet and optionally further subsequent packets of the plurality of packets of the atomic transaction in the write FIFO buffer.

18. The method according to claim 16,
wherein the respective plurality of packets of a respective atomic transaction of each of the one or more atomic transactions comprises an end packet indicating reception of all packets of the respective plurality of packets and wherein the atomic transaction represents a data update to page data of a page of a plurality of pages, wherein a page table comprises a respective page table entry for each page of the plurality of pages; and
wherein the method further comprises: in response to receiving the end packet of the atomic transaction, adapting the respective page table entry of the page to indicate that the write FIFO buffer stores the atomic transaction for updating the page data of the page.

19. The method according to claim 18,
wherein the respective page table entry is further adapted to indicate a respective position of each of the respective plurality of packets of the atomic transaction within the write FIFO buffer.

20. The method according to claim 18, further comprising:
in response to receiving, from a processing unit, a read request for providing page data of a page of the plurality of pages, in the case that the respective page table entry of the respective page indicates that the write FIFO buffer stores an atomic transaction for updating the respective page, merging the corresponding data of the atomic transaction with the page data of the respective page prior to providing them to the processing unit.
